(19) United States
(12) Patent Application Publication
(10) Pub. No.: US 2026/0119005 A1
(43) Pub. Date: Apr. 30, 2026

(54) ELECTRONIC APPARATUS AND CONTROL METHOD THEREOF

(71) Applicant: SAMSUNG ELECTRONICS CO., LTD., Suwon-si (KR)

(72) Inventors: Celine PARK, Suwon-si (KR); Woonghee LEE, Suwon-si (KR); Youngeun OH, Suwon-si (KR); Heejin KO, Suwon-si (KR); Changsoo NOH, Suwon-si (KR); Seunghwan LEE, Suwon-si (KR)

(73) Assignee: SAMSUNG ELECTRONICS CO., LTD., Suwon-si (KR)

(21) Appl. No.: 19/420,005

(22) Filed: Dec. 15, 2025

Related U.S. Application Data
(63) Continuation of application No. PCT/KR2025/014422, filed on Sep. 16, 2025.

(30) Foreign Application Priority Data
Oct. 15, 2024 (KR) 10-2024-0140493

(51) Int. Cl. G06F 3/0482; G06F 3/0489; G06F 9/451; G06F 21/36

(52) U.S. Cl. CPC G06F 3/0482; G06F 3/0489; G06F 9/451; G06F 21/36

(57) ABSTRACT

An electronic apparatus is configured to display a pattern input user interface (UI), display a first UI element differently from remaining UI elements based on a first selection while a focus is placed on the first UI element, move the focus from the first UI element onto a second UI element and display a first guide trajectory coupling the first UI element with the second UI element, based on a first movement, and, based on a second selection while the focus is placed on the second UI element and the first guide trajectory is displayed, display the first and second UI elements differently from the remaining UI elements of the plurality of UI elements, change the first guide trajectory to a first selection trajectory, and display the first selection trajectory.

### CROSS-REFERENCE TO RELATED APPLICATIONS

This application is a continuation application of International Application No. PCT/KR2025/014422, filed on Sep. 16, 2025, which claims priority to Korean Patent Application No. 10-2024-0140493, filed on Oct. 15, 2024, in the Korean Intellectual Property Office, the disclosures of which are incorporated by reference herein in their entireties.

### BACKGROUND

### 1. Field

The present disclosure relates generally to electronic apparatuses and control methods thereof, and more particularly, to an electronic apparatus capable of receiving a pattern input through a user interface (UI) displayed on a display, and a control method thereof.

### 2. Description of Related Art

Recently, a method by which a password is input based on a pattern input may have been used in hand-held electronic devices, such as, but not limited to, a touch screen-based mobile device. In the method, for example, a user may draw a pattern directly by touching user interface (UI) elements on a touch screen as a means of entering an input value to the device while protecting privacy for the user.

However, the pattern input method may not be appropriate for other electronic devices that may be controlled based on a remote controller and/or another input device rather than a touch screen, such as, but not limited to a television (TV) or the like. That is, a user may find it difficult to perform an operation of inputting a password or the like based on the above-described pattern input.

Consequently, there may be a growing demand for a method of performing a pattern input by using an input device (e.g., a remote controller or the like) for electronic apparatuses that may lack a touch screen.

The above-described particulars may be provided as related art aiming for a better understanding of the present disclosure. Any argument or determination is not raised as to whether any of the particulars is applicable as prior art associated with the present disclosure.

### SUMMARY

According to an aspect of the present disclosure, an electronic apparatus includes a display, memory storing instructions, and a processor. The instructions, when executed by the processor individually or collectively, cause the electronic apparatus to display, on the display, a pattern input user interface (UI) configured to perform a pattern input, based on receiving a first user input including a first instruction instructing to perform a first selection while a focus is placed on a first UI element from among the plurality of UI elements, display the first UI element in a manner that differentiates the first UI element from remaining UI elements of the plurality of UI elements, based on receiving a second user input including a second instruction instructing to perform a first movement in a first direction while the first UI element is selected, move the focus from the first UI element onto a second UI element of the plurality of UI elements disposed in the first direction from the first UI element, and display a first guide trajectory coupling the first UI element with the second UI element, and, based on receiving a third user input including a third instruction instructing to perform a second selection while the focus is placed on the second UI element and the first guide trajectory is displayed, display the first UI element and the second UI element in a manner that differentiates the first UI element and the second UI element from remaining UI elements of the plurality of UI elements, change the first guide trajectory to a first selection trajectory, and display the first selection trajectory. The pattern input UI includes a plurality of UI elements.

The instructions, when executed by the processor individually or collectively, may further cause the electronic apparatus to, based on receiving a fourth user input including a fourth instruction to perform a second movement in a second direction while the focus is placed on the second UI element and the first guide trajectory is displayed, move the focus from the second UI element onto a third UI element of the plurality of UI elements disposed in the second direction from the second UI element, and display a second guide trajectory coupling the first UI element with the third UI element.

The instructions, when executed by the processor individually or collectively, may further cause the electronic apparatus to, based on the second direction being equal to the first direction, couple, using the second guide trajectory, the first UI element and the second UI element with the third UI element.

The instructions, when executed by the processor individually or collectively, may further cause the electronic apparatus to, based on receiving a fifth user input including a fifth instruction to perform a third selection while the focus is placed on the third UI element and the second guide trajectory is displayed, display the first UI element, the second UI element, and the third UI element in a manner that differentiates the first UI element, the second UI element, and the third UI element from remaining UI elements of the plurality of UI elements, change the second guide trajectory to a second selection trajectory, and display the second selection trajectory.

The instructions, when executed by the processor individually or collectively, may further cause the electronic apparatus to, based on the second direction being a direction diagonal to the first direction, couple, using the second guide trajectory, only the first UI element with the third UI element disposed diagonally from the first UI element.

The instructions, when executed by the processor individually or collectively, may further cause the electronic apparatus to, based on receiving a sixth user input including a sixth instruction instructing to perform a fourth selection while the focus is placed on the third UI element and the second guide trajectory is displayed, display the first UI element and the third UI element in a manner that differentiates the first UI element and the third UI element from remaining UI elements of the plurality of UI elements, change the second guide trajectory to a third selection trajectory, and display the third selection trajectory.

The instructions, when executed by the processor individually or collectively, may further cause the electronic apparatus to, based on the first guide trajectory being changed to the first selection trajectory, provide a feedback effect by changing a color of the first guide trajectory.

In the electronic apparatus, the plurality of UI elements may include a corresponding number of UI elements. The instructions, when executed by the processor individually or collectively, may further cause the electronic apparatus to display, together with the pattern input UI, a number UI configured to select a number by using a direction key.

The instructions, when executed by the processor individually or collectively, may further cause the electronic apparatus to, based on selecting a first number included in the number UI once, receive a fourth user input including a fourth instruction instructing to perform a second movement in a direction of the first number and, based on selecting a second number included in the number UI twice, receive a fifth user input including a fifth instruction to perform a third selection of the second number.

According to an aspect of the present disclosure, a control method of an electronic apparatus includes displaying, on a display of the electronic apparatus, a pattern input UI including a plurality of UI elements, based on receiving a first user input including a first instruction instructing to perform a first selection while a focus is placed on a first UI element from among the plurality of UI elements, displaying the first UI element in a manner that differentiates the first UI element from remaining UI elements of the plurality of UI elements, based on receiving a second user input including a second instruction instructing to perform a first movement in a first direction while the first UI element is selected, moving the focus from the first UI element onto a second UI element of the plurality of UI elements disposed in the first direction from the first UI element, and displaying a first guide trajectory coupling the first UI element with the second UI element, and, based on receiving a third user input including a third instruction instructing to perform a second selection while the focus is placed on the second UI element and the first guide trajectory is displayed, displaying the first UI element and the second UI element in a manner that differentiates the first UI element and the second UI element from remaining UI elements of the plurality of UI elements, changing the first guide trajectory to a first selection trajectory, and displaying the first selection trajectory.

The control method may further include, based on receiving a fourth user input including a fourth instruction to perform a second movement in a second direction while the focus is placed on the second UI element and the first guide trajectory is displayed, moving the focus from the second UI element onto a third UI element of the plurality of UI elements disposed in the second direction from the second UI element, and displaying a second guide trajectory coupling the first UI element with the third UI element.

The control method may further include, based on the second direction being equal to the first direction, coupling, using the second guide trajectory, the first UI element and the second UI element with the third UI element.

The control method may further include, based on receiving a fifth user input including a fifth instruction to perform a third selection while the focus is placed on the third UI element and the second guide trajectory is displayed, displaying the first UI element, the second UI element, and the third UI element in a manner that differentiates the first UI element, the second UI element, and the third UI element from remaining UI elements of the plurality of UI elements, changing the second guide trajectory to a second selection trajectory, displaying the second selection trajectory.

The control method may further include, based on the second direction being a direction diagonal to the first direction, coupling, using the second guide trajectory, only the first UI element with the third UI element disposed diagonally from the first UI element.

The control method may further include, based on receiving a sixth user input including a sixth instruction instructing to perform a fourth selection while the focus is placed on the third UI element and the second guide trajectory is displayed, displaying the first UI element and the third UI element in a manner that differentiates the first UI element and the third UI element from remaining UI elements of the plurality of UI elements, changing the second guide trajectory to a third selection trajectory, and displaying the third selection trajectory.

The control method may further include, based on the first guide trajectory being changed to the first selection trajectory, providing a feedback effect by changing a color of the first guide trajectory.

The control method may further include displaying, together with the pattern input UI, a number UI configured to select a number by using a direction key. The plurality of UI elements includes a corresponding number of UI elements.

The control method may further include, based on selecting a first number included in the number UI once, receiving a fourth user input including a fourth instruction instructing to perform a second movement in a direction of the first number, and, based on selecting a second number included in the number UI twice, receiving a fifth user input including a fifth instruction to perform a third selection of the second number.

According to an aspect of the present disclosure, a control method of an electronic apparatus includes displaying, on a display of the electronic apparatus, based on receiving a first user input including a first instruction instructing to perform a first selection while a focus is placed on a first UI element from among the plurality of UI elements, displaying the first UI element in a manner that differentiates the first UI element from remaining UI elements of the plurality of UI elements, based on receiving a second user input including a second instruction instructing to perform a first movement in a first direction while the first UI element is selected, moving the focus from the first UI element onto a second UI element of the plurality of UI elements disposed in the first direction from the first UI element, and displaying a first guide trajectory coupling the first UI element with the second UI element, based on receiving a third user input including a third instruction instructing to perform a second selection while the focus is placed on the second UI element and the first guide trajectory is displayed, displaying the first UI element and the second UI element in a manner that differentiates the first UI element and the second UI element from remaining UI elements of the plurality of UI elements, changing the first guide trajectory to a first selection trajectory, and displaying the first selection trajectory, based on receiving a fourth user input including a fourth instruction to perform a second movement in a second direction while the focus is placed on the second UI element and the first guide trajectory is displayed, move the focus from the second UI element onto a third UI element of the plurality of UI elements disposed in the second direction from the second UI element, and display a second guide trajectory coupling the first UI element with the third UI element, based on receiving a fifth user input including a fifth instruction to perform a third selection while the focus is placed on the third UI element and the second guide trajectory is displayed, display the first UI element, the second UI element, and the third UI element in a manner that differentiates the first UI element, the second UI element, and the third UI element from remaining UI elements of the plurality of UI elements, change the second guide trajectory to a second selection trajectory, and display the second selection trajectory, and, based on receiving a sixth user input including a sixth instruction instructing to perform a fourth selection while the focus is placed on the third UI element and the second guide trajectory is displayed, display the first UI element and the third UI element in a manner that differentiates the first UI element and the third UI element from remaining UI elements of the plurality of UI elements, change the second guide trajectory to a third selection trajectory, and display the third selection trajectory.

The control method may further include displaying, together with the pattern input UI, a number UI configured to select a number by using a direction key, and, based on selecting a first number included in the number UI once, receive a seventh user input including a seventh instruction instructing to perform a third movement in a direction of the first number, and, based on selecting a second number included in the number UI twice, receive an eighth user input including an eighth instruction to perform a fourth selection of the second number. The plurality of UI elements may include a corresponding number of UI elements.

Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure may be more apparent from the following description, taken in conjunction with the accompanying drawings, in which:

FIG. 1 is a block diagram of a configuration of an electronic apparatus, according to an embodiment;

FIGS. 2A and 2B are flowcharts illustrating a method of controlling a user interface (UI) for a pattern input, according to an embodiment;

FIGS. 3A, 3B, 3C, 3D, 3E, 3F, 3G, 3H, and 3I are views illustrating a method of controlling a pattern input UI, according to an embodiment;

FIGS. 4A and 4B are views illustrating a method by which user authentication is performed by using a pattern input UI and a number UI, according to an embodiment;

FIG. 5 is a flowchart illustrating a method by which user authentication is performed by using a pattern input UI and a number UI, according to an embodiment;

FIG. 6 is a view of an electronic apparatus and a user terminal, according to an embodiment;

FIGS. 7A and 7B are views illustrating interworking between an electronic apparatus and a user terminal and performing a pattern input, according to an embodiment;

FIG. 8 is a view illustrating performing a pattern input based on a user voice, according to an embodiment; and

FIG. 9 is a view illustrating performing a pattern input based on a user gesture, according to an embodiment.

### DETAILED DESCRIPTION

Various embodiments set forth herein and terms used herein are not intended to limit technical features of the subject matter of the disclosure to those of specific embodiments thereof, and it is to be understood that the embodiments set forth herein include various modifications, equivalents or alternatives thereof.

In description of the drawings, like reference numerals may be used to indicate like or relevant elements.

Unless explicitly stated otherwise, a singular form corresponding to an item may include a singular form or a plural form thereof.

In the disclosure, each of the phrases such as “A or B,” “at least one of A and B,” “at least one of A or B,” “A, B or C,” “at least one of A, B and C,” and “at least one of A, B or C” may include any one of the items listed together in a corresponding phrase or all possible combinations thereof. For example, “A or B,” “at least one of A and B,” or “at least one of A or B” may refer to all cases including (1) at least one A, (2) at least one B, or (3) both of at least one A and at least one B.

In the disclosure, a term such as “1st,” “2nd,” or “first,” or “second” may be used merely to differentiate one element from another but not to limit the elements in another aspect (e.g., importance or order).

Based on one element (e.g., a first element) referred to as being “coupled with/to or connected with/to” another element (e.g., a second element) with or without the term “functionally” or “communicatively”, it is to be understood that one element may be connected to another element directly (e.g., in a wired manner), in a wireless manner, or through yet another element (e.g., a third element).

In the disclosure, terms such as “include,” or “have” or the like are used to indicate the presence of stated features, numbers, steps, operations, elements, components or a combination thereof, and do not imply exclusion of the presence or addition of one or more different features, numbers, steps, operations, elements, components or a combination thereof.

Based on one element referred to as being “connected with/to,” “coupled with/to,” “supporting,” or “contacting” another element, it is to be understood that one element is connected with/to another element, is coupled with/to another element, supports another element, or contacts another element directly or indirectly through yet another element (e.g., a third element).

Based on one element referred to as being placed “on” another element, it is to be understood that one element contacts another element and that yet another element is present between the two elements.

The term “and/or” denotes including a combination or any of a plurality of relevant elements described.

In a certain situation, the expression “a device configured to . . . ” may denote “being capable of performing” by the device together with another device or other components. For example, the phrase “a processor configured (or set) to perform A, B and C” may mean an exclusive processor (e.g., an embedded processor) for performing the functions, or a generic-purpose processor (e.g., a central processing unit (CPU) or an application processor) capable of performing the functions by executing one or more software programs stored in a memory device.

In the embodiments, the term “module” or “unit” may perform at least one function or operation, and be implemented by hardware or software or by a combination of hardware and software. Additionally, a plurality of “modules” or a plurality of “units” may be integrated into at least one module and be implemented as at least one processor except for a “module” or a “unit” that may need to be implemented by specific hardware.

Various elements and regions in the drawings are schematically illustrated. Accordingly, the technical spirit of the disclosure is not limited by relative sizes or distances illustrated in the accompanying drawings.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereafter, the subject matter of the present disclosure is described in greater detail with reference to the accompanying drawings.

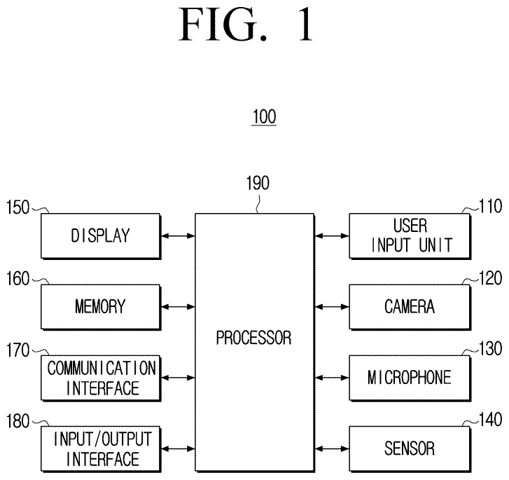

FIG. 1 is a block diagram of a configuration of an electronic apparatus, according to an embodiment of the disclosure. An electronic apparatus 100, according to embodiments, may include a user input unit 110, a camera 120, a microphone 130, a sensor 140, a display 150, memory 160, a communication interface 170, and a processor 190, as illustrated in FIG. 1. However, this is merely construed as an embodiment, and certainly, some of the elements may be removed or other elements may be added based on a type of an electronic apparatus 100. For example, in a case where the electronic apparatus 100 is implemented as a set-top box (STB), the electronic apparatus 100 may not include the display 150.

The user input unit 110, as an element for receiving a user input for controlling the electronic apparatus 100, may include a button, a level, a switch, a touch-type interface, a keyboard, a mouse or the like. In particular, the user input unit 110 may include a remote controller including a direction key for movement in four directions (e.g., up, down, right, left) and a key for selection. As used herein, a user input may be referred to as various terms such as, but not limited to, a user instruction, a user interaction, or the like.

The camera 120 may capture a still image and/or a moving image. The camera 120, according to embodiments, may include one or more lenses, an image sensor, an image signal process, and a flash. The one or more lenses may include, but not be limited to, a telephoto lens, a wide angle lens, and a super wide angle lens that may be disposed on the surface of the electronic apparatus 100. Alternatively, the camera 120 may also include a three-dimensional (3D) depth lens. The camera 120 may be disposed on the surface (e.g., a rear surface or a front surface) of the electronic apparatus 100. However, embodiments of the present disclosure are not limited to the above-described configuration. For example, embodiments of the present disclosure may be implemented based on a camera 120 that may separately exist outside the electronic apparatus 100.

In an embodiment, the camera 120 may obtain an image including a user gesture for controlling the electronic apparatus 100 by capturing an image of the user. For example, the camera 120 may capture an image of a gesture including movement of the user's hand.

The microphone 130 may refer to a device that may sense a sound and may convert the sound into an electrical signal. For example, the microphone 130 may sense a voice in real time, and may convert the sensed voice into an electrical signal, such that the electronic apparatus 100 may perform an operation corresponding to the electrical signal. The microphone 130 may include a text-to-speech (TTS) module and/or a speech-to-text (STT) module. The microphone 130 may be included as an element of an input device and/or as an element of the electronic apparatus 100.

In an embodiment, the microphone 130 may receive a user voice for controlling a user interface (UI) for a pattern input. For example, the user voice may include a plurality of numbers and/or words.

The sensor 140 may sense a state (e.g., movement) of the electronic apparatus 100, and/or a state of an external environment (e.g., a user state), and may generate an electrical signal and/or a data value corresponding to the sensed state. The sensor 140, for example, may include, but not be limited to, a gesture sensor, an acceleration sensor, or the like.

Additionally, the sensor 140 may include a time of flight (ToF) sensor such as, but not limited to, an infrared sensor, an ultrasonic sensor or the like to obtain information on a distance from an object (e.g., the user's hand).

The display 150 may be and/or may include one or more of various types of panels such as, but not limited to, a liquid crystal display (LCD) panel, an organic light emitting diode (OLED) panel, an active-matrix organic light-emitting diode (AM-OLED) panel, a liquid crystal on silicon (LcoS) panel, a quantum dot light-emitting diode (QLED) panel, and a digital light processing (DLP) panel, a plasma display panel (PDP), an inorganic light emitting diode (LED) panel, a micro LED panel, or the like. In an embodiment, the display 150 may constitute a touch screen together with a touch panel. Alternatively or additionally, the display 150 may be and/or may include a flexible panel.

In an embodiment, the display 150 may display a UI for a pattern input. Herein, the pattern input UI may include a plurality of UI elements, and may be a UI for inducing (and receiving) successive selections of the plurality of UI elements. That is, the pattern input UI may receive information on the order in which the plurality of UI elements are to be displayed, as well as, information on which UI element is selected that may be different from related password input UIs. Accordingly, user authentication using the pattern UI may be performed based on enhanced security when compared to the related password input UIs. In an embodiment, the pattern input UI may include a plurality of UI elements, and each of the plurality of UI elements may include an indicator (or an icon) such as, but not limited to, a number or a letter.

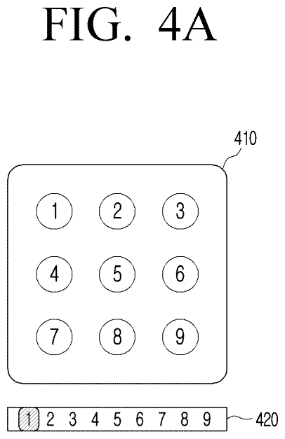

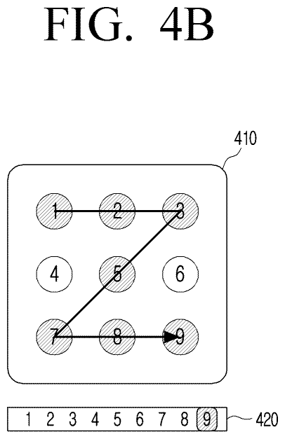

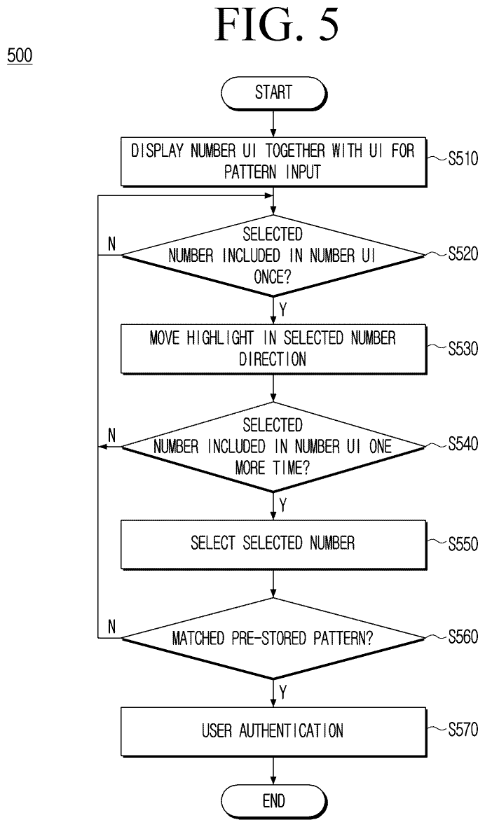

In an embodiment, the display 150 may display a number UI together with the pattern input UI. The number UI may be a UI that may display a plurality of numbers listed in a row, as described below with reference to FIGS. 4A, 4B, and 5.

The memory 160 may store an operating system (OS) for controlling entire operations of the elements of the electronic apparatus 100 and instructions and/or data in association with the elements of the electronic apparatus 100. That is, the memory 160 may include a plurality of modules for controlling the pattern input UI. For example, based on executing the plurality of modules for controlling the pattern input UI, the electronic apparatus 100 may load data for various types of modules stored in non-volatile memory to perform various operations to volatile memory. As used herein, the loading procedure may refer to an operation of fetching the data stored in the non-volatile memory and storing the fetched data in the volatile memory such that the processor 190 may access the data.

The memory 160 may be and/or may include non-volatile memory (e.g., a hard disk, solid-state drive (SSD), flash memory), volatile memory (also including memory in a processor 190), or the like.

In an embodiment, the memory 160 may store pre-set pattern information for performing user authentication. For example, based on matching the pre-set pattern information and pattern information input through the pattern input UI, the electronic apparatus 100 may perform user authentication.

The communication interface 170 may include at least one circuit, and may perform communication with various types of external devices and/or servers. The communication interface 170 may be and/or may include at least one of a Bluetooth™ module, a Bluetooth™ low energy (BLE) module, a Wireless-Fidelity (Wi-Fi) communication module, a cellular communication module, a third-generation (3G) mobile communication module, a ultra wideband (UWB) communication module, a fourth-generation (4G) mobile communication module, a 4G long term evolution (LTE) communication module, a fifth-generation (5G) mobile communication module, or the like.

In an embodiment, the communication interface 170 may perform communication with an external user terminal, and transmit, to the external user terminal, pattern information input onto the pattern input UI.

An input/output (I/O) interface 180 may be and/or may include an element for inputting and/or outputting at least one of an audio signal or a video signal. In an example, the I/O interface 180 may be and/or may include a high definition multimedia interface (HDMI). Alternatively or additionally, the I/O interface 180 may be and/or may include an interface for at least one of mobile high-definition link (NML), universal serial bus (USB), display port (DP), Institute of Electrical and Electronics Engineers (IEEE) 1394 (FireWire), Thunderbolt™, a video graphics array (VGA) port, an red-green-blue (RGB) port, a D-subminiature (D-SUB) port, a digital visual interface (DVI), or the like. In an embodiment, the I/O interface 180 may separately include a first port inputting and/or outputting an audio signal only and a second port inputting and/or outputting a video signal only. Alternatively, the I/O interface 180 may be and/or may include at least one port for inputting and/or outputting both an audio signal and a video signal. In an embodiment, the electronic apparatus 100 may obtain at least one input image through the I/O interface 180.

The processor 190 may control an overall operation of the electronic apparatus 100 according to at least one instruction stored in the memory 160.

In an embodiment, the processor 190 may include one or more processors. For example, the one or more processors may include one or more of a central processing unit (CPU), a graphics processing unit (GPU), an accelerated processing unit (APU), many integrated core (MIC), a digital signal processor (DSP), a neural processing unit (NPU), a hardware accelerator, a machine learning accelerator, or the like. The one or more processors may control one among other elements of the electronic apparatus or any combination thereof, and may perform an operation in association with communication or data processing. The one or more processors may execute, individually or collectively, one or more programs or instructions stored in the memory. For example, the one or more processors may perform a method, according to an embodiment, by executing, individually or collectively, one or more instructions stored in the memory.

That is, when a method includes a plurality of operations, the plurality of operations may be performed by one processor, or by a plurality of processors. For example, when a first operation, a second operation, and a third operation are to be performed based on the method, the first operation, the second operation and the third operation may all be performed by a first processor, or the first operation and the second operation may be performed by the first processor (e.g., a generic-purpose processor), while the third operation may be performed by a second processor (e.g., an artificial intelligence (AI)-exclusive processor).

The one or more processors may be implemented as a single core processor including one core, and/or as one or more multicore processors including a plurality of cores (e.g., a homogeneous multi core or a heterogeneous multi core). In a case where the one or more processors are implemented as a multicore processor, each of the plurality of cores included in the multicore processor may include processor internal memory such as, but not limited to, cache memory, and on-chip memory, and common cache shared by the plurality of cores may be included in the multicore processor. Additionally, each of the plurality of cores (or part of the plurality of cores) included in the multicore processor may read and/or perform a program instruction for implementing the method independently or in a manner that all (or part) of the plurality of cores are associated.

In an embodiment, when the method includes a plurality of operations, the plurality of operations may be performed by one of the plurality of cores and/or may be performed by the plurality of cores included in the multicore processor. For example, in a case where a first operation, a second operation, and a third operation are to be performed based on the method, the first operation, the second operation, and the third operation may all be performed by a first core included in the multicore processor. Alternatively, the first operation and the second operation may be performed by the first core included in the multicore processor, while the third operation may be performed by a second core included in the multicore processor.

In an embodiment, the processor 190 may denote a system on a chip (SoC) where one or more processors and other electronic components are integrated, a single core processor, a multicore processor, or a core included in a single core processor or a multicore processor, and herein, the core may be implemented as a CPU, a GPU, an APU, an MIC, a DSP an NPU, a hardware accelerator or a machine learning accelerator or the like, but embodiments thereof may not be limited thereto.

For example, by executing at least one instruction, the processor 190 may display a pattern input UI including a plurality of UI elements on the display 150, based on receiving a first user input including an instruction for selection while a focus is placed on a first UI element among the plurality of UI elements, may display the first UI element in a manner that differentiates the first UI element from another UI element, based on receiving a second user input including an instruction for movement in a first direction while the first UI element is selected, may move the focus onto a second UI element placed in a first direction of the first UI element and may display a first guide trajectory connecting the first UI element and the second UI element, and based on receiving a third user input including an instruction for selection while the focus is placed on the second UI element and a first guide line is displayed, may display the first and second UI elements in a manner that differentiates the first and second UI elements from another UI element, may change the first guide trajectory to a first selection trajectory, and may display the first selection trajectory.

According to one or more embodiments, based on receiving a fourth user input including an instruction for movement in a second direction while the focus is placed on the second UI element and the first guide line is displayed, the processor 190 may move the focus onto a third UI element placed in a second direction of the second UI element, and may display a second guide trajectory connecting the first UI element and the third UI element.

According to one or more embodiments, in a case where the second direction is equal to the first direction, the second guide trajectory may be a trajectory connecting the first UI element, the second UI element, and the third UI element. In such embodiments, based on receiving a fifth user input including an instruction for selection while the focus is placed on the third UI element and a second guide line connecting the first UI element, the second UI element, and the third UI element is displayed, the processor 190 may display the first UI element, the second UI element, and the third UI element in a manner that differentiates the first UI element, the second UI element, and the third UI element from another UI element, may change the second guide trajectory to a second selection trajectory, and may display the second selection trajectory.

According to one or more embodiments, in a case where the second direction is a direction diagonal to the first direction, the second guide trajectory may be a trajectory only connecting the first UI element and the third UI element placed diagonally to the first UI element. However, embodiments of the present disclosure are not limited in this regard, and the second direction may be a direction perpendicular to the first direction, and the resulting second guide trajectory may be a trajectory only connecting the first UI element and a third UI element placed in a direction perpendicular to the first direction from the first UI element. In such embodiments, based on receiving a sixth user input including an instruction for selection while the focus is placed on the third UI element and the second guide line connecting the first UI element and the third UI element is displayed, the processor 190 may display the first UI element and the third UI element in a manner that differentiates the first UI element and the third UI element from another UI element, may change the second guide trajectory to a third selection trajectory, and may display the third selection trajectory.

According to one or more embodiments, when changing the first guide trajectory to the first selection trajectory, the processor 190 may change the first guide trajectory to the first selection trajectory, and may display the first selection trajectory while providing a feedback effect of changing a color of the first guide trajectory.

According to one or more embodiments, the plurality of UI elements may include a corresponding number of UI elements. The processor 190 may display a number UI for selecting a number by using a direction key, together with the pattern input UI, on the display 150. In such embodiments, based on selecting a number included in the number UI once, the processor 190 may receive a user input including an instruction for movement in a direction of the selected number, and based on selecting a number included in the number UI twice, the processor 190 may receive a user input including an instruction for selection of the selected number.

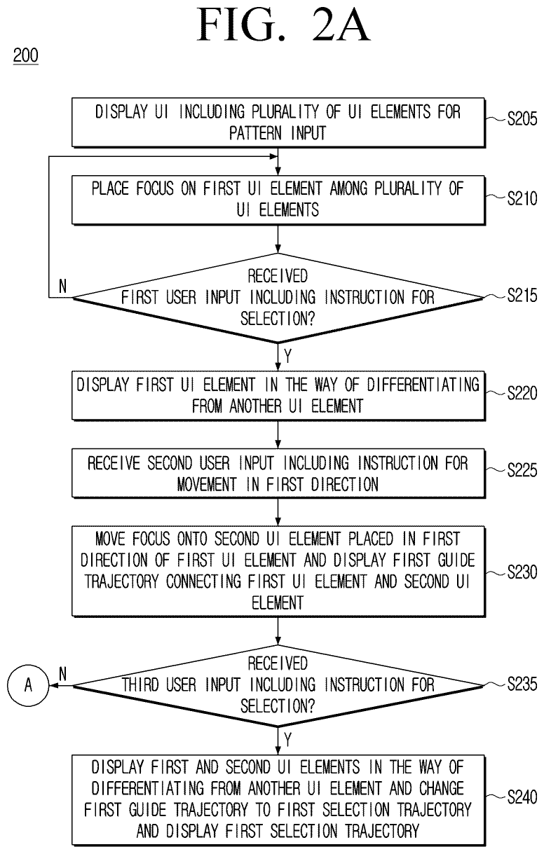

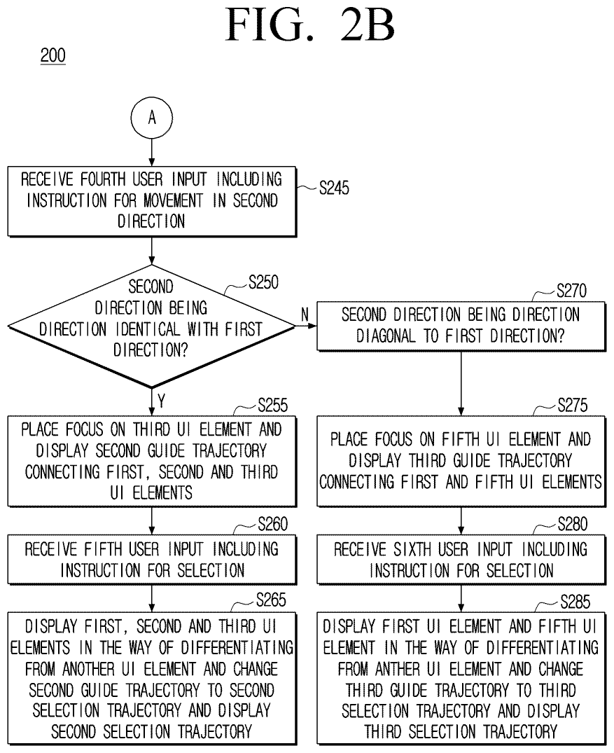

FIGS. 2A and 2B are flowcharts illustrating a method of controlling a pattern input UI, according to an embodiment.

Referring to FIGS. 2A and 2B, each of the operations of the method 200 of controlling the pattern input UI may be performed sequentially, but may not necessarily be performed sequentially. For example, the order of each of the operations may be changed, and at least two (2) of the operations may be performed in parallel.

According to an embodiment, operations S205 to S285 may be performed by a processor (e.g., processor 190 of FIG. 1) of an electronic apparatus (e.g., electronic apparatus 100 of FIG. 1).

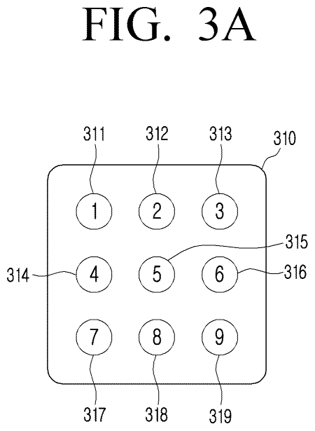

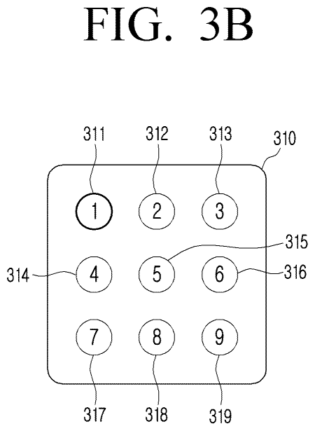

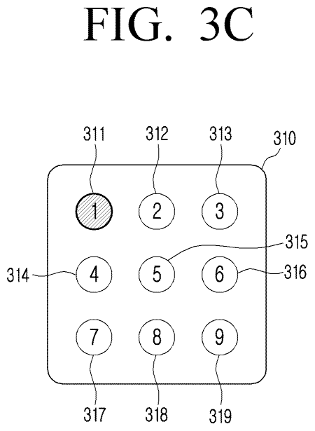

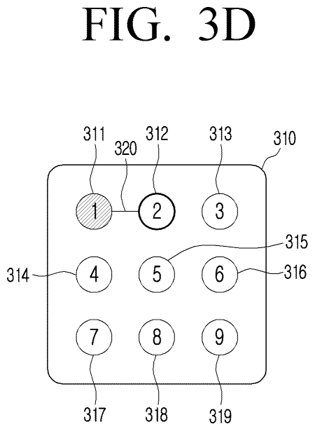

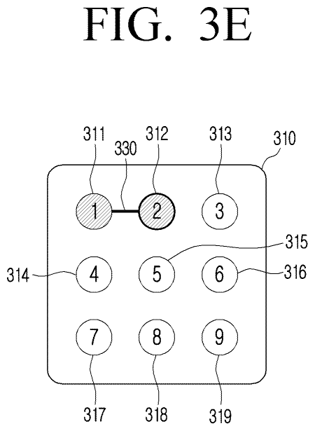

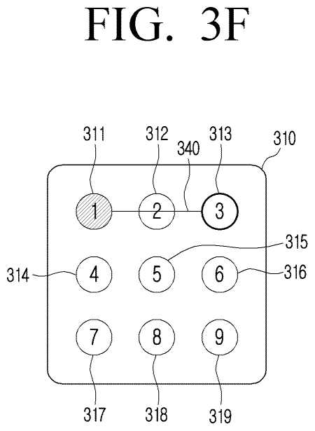

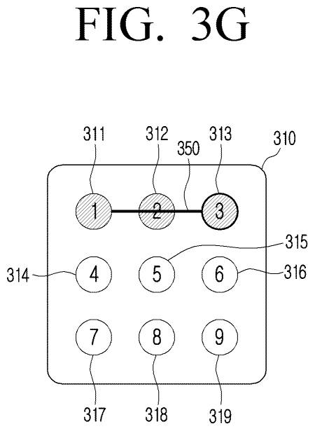

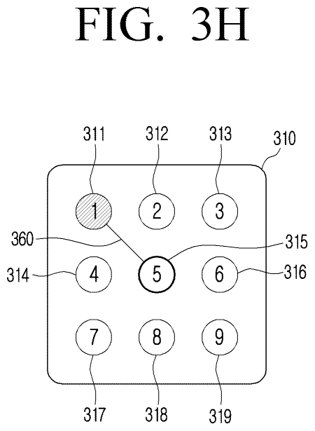

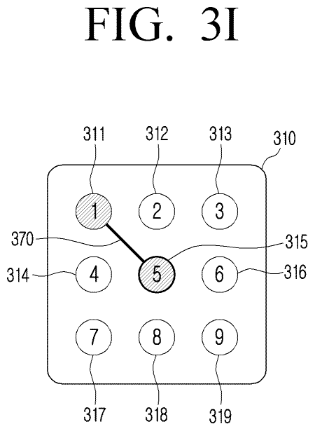

According to the method 200, the electronic apparatus 100 may display a pattern input UI including a plurality of UI elements for a pattern input (operation S205). Referring to FIG. 3A, an example of a pattern input UI is illustrated. As shown in FIG. 3A, the pattern input UI 310 may include a plurality of UI elements (e.g., a first UI element 311, a second UI element 312, a third UI element 313, a fourth UI element 314, a fifth UI element 315, a sixth UI element 316, a seventh UI element 317, an eighth UI element 318, and a ninth UI element 319) that may be disposed in a square form. However, embodiments of the present disclosure are not limited thereto, and the pattern input UI 310 may include a different number of UI elements (e.g., less than nine (9), or more than nine (9)). As another example, the pattern input UI 310 may further include another UI element (e.g., zero (0), star (*), hashtag (#), letter (A to Z), or the like). Each of the plurality of UI elements 311 to 319 may include a corresponding number. For example, as shown in FIG. 3A, the first UI element 311 may correspond to the number one (1), the second UI element 312 may correspond to the number two (2), the third UI element 313 may correspond to the number three (3), the fourth UI element 314 may correspond to the number four (4), the fifth UI element 315 may correspond to the number five (5), the sixth UI element 316 may correspond to the number six (6), the seventh UI element 317 may correspond to the number seven (7), the eighth UI element 318 may correspond to the number eight (8), and the ninth UI element 319 may correspond to the number nine (9).

The electronic apparatus 100 may display the pattern input UI 310 in a manner that a focus is placed on the first UI element 311 from among the plurality of UI elements 311 to 319 (operation S210). The focus may serve as an indicator for guiding a user as to which of the plurality of UI elements 311 to 319 is currently selectable. In an embodiment, the focus may be displayed along the outline of the UI element. For example, the focus, as illustrated in FIG. 3B, may be placed on the first UI element 311 from among the plurality of UI elements 311 to 319, and may be indicated by displaying the first UI element 311 with a thicker border, when compared to the border of the remaining UI elements of the plurality of elements 311 to 319. However, embodiments of the present disclosure are not limited in this regard, and the focus may be placed on a UI element on which the focus has been placed most recently from among the plurality of UI elements 311 to 319. Alternatively, the focus may be placed on a UI element designated by the user. As another example, the focus may be indicated by modifying one or more characteristics of the selected UI element (e.g., size, shape, color, font, or the like). As used herein, the focus may alternatively be referred to as a highlight or the like.

The electronic apparatus 100 may identify whether a first user input including an instruction for selection is received (or obtained, input or the like) (operation S215). The first user input including the instruction for selection may be and/or may include a user input such as, but not limited to, selecting (or pressing) a key or button (e.g., Enter, Select, or the like) that may be included in an input device of the electronic apparatus 100 (e.g., a remote controller, a keyboard, a touch screen, or the like).

Based on receiving the first user input including the instruction for selection (operation S215) (Y in operation S215), the electronic apparatus 100 may display the first UI element 311 in a manner that differentiates the first UI element 311 from another UI element (e.g., the second to ninth UI elements 312 to 319). Alternatively, based on determining that the first user input has not been received, the method 200 may return to operation S210 and wait for the first user input (N in operation S215).

In one or more embodiments, based on receiving the first user input including the instruction for selection while the focus is displayed on the first UI element 311 as illustrated in FIG. 3B (Y in operation S215), the electronic apparatus 100, as illustrated in FIG. 3C, may display the selected first UI element 311 in a manner that differentiates the first UI element 311 from another (remaining) UI element (e.g., the second to ninth UI elements 312 to 319). For example, the electronic apparatus 100 may display the selected first UI element 311 by adjusting the brightness, color, saturation or the like of the selected first UI element 311 in a manner that differentiates the selected first UI element 311 from another UI element (e.g., the second to ninth UI elements 312 to 319).

The electronic apparatus 100 may receive a second user input including an instruction for movement in a first direction (operation S225). The second user input including the instruction for movement in a first direction may be and/or may include a user input selecting a first direction from direction buttons (e.g., up, down, left, right) that may be included in the remote controller. However, embodiments of the present disclosure are not limited thereto.

The electronic apparatus 100 may move the focus onto a second UI element 312 placed in the first direction of the first UI element 311, and may display a first guide trajectory connecting the first UI element 312 and the second UI element 312 (operation S230). The guide trajectory may be and/or may include a line for guiding a selected trajectory, in a case where the user selects a UI element at which the focus is placed (e.g., the first UI element 311). In one or more embodiments, based on receiving a user input for movement in a right direction in the state where the first UI element 311 is selected, as illustrated in FIG. 3C, the electronic apparatus 100, as illustrated in FIG. 3D, may move the focus to the second UI element 312 placed at the right side of the first UI element 311, and may display a first guide trajectory 320 connecting between the first UI element 311 and the second UI element 312.

The electronic apparatus 100 may identify whether a third user input including an instruction for selection is received (operation S235). The third user input including the instruction for selection may be and/or may include a user input selecting an Enter button and/or a Select button that may be included in a remote controller. However, the embodiments of the present disclosure are not limited thereto.

Based on receiving the third user input including the instruction for selection (Y in operation S235), the electronic apparatus 100 may display the first and second UI elements 311 and 312 in a manner that differentiates the first and second UI elements 311 and 312 from another UI element (e.g., the third to ninth UI elements 313 to 319), and change the first guide trajectory to a first selection trajectory and display the first selection trajectory (operation S240). Alternatively, based on determining that the third user input has not been received, the method 200 may proceed to operation S245 (N in operation S235).

In one or more embodiments, based on receiving the third user input including the instruction for selection while the first UI element 311 is selected and the focus is placed on the second UI element 312 as illustrated in FIG. 3D (Y in operation S235), the electronic apparatus 100, as illustrated in FIG. 3E, may display the first and second UI elements 311 and 312 in a manner that differentiates the first and second UI elements 311 and 312 from another UI element (e.g., the third to ninth UI elements 313 to 319), change the first guide trajectory 320 to the first selection trajectory 330, and display the first selection trajectory 330. The selection trajectory may represent a line indicating a trajectory selected by a user input including an instruction for selection. In an embodiment, the selection trajectory may be displayed in a manner different from the manner in which the guide trajectory is displayed. For example, the first guide trajectory 320, as illustrated in FIGS. 3D and 3E, may be displayed more thinly than the first selection trajectory 330. However, embodiments of the present disclosure are not limited thereto, and the color, brightness, blink rate, or the like of the first guide trajectory 320 and the first selection trajectory 330 may be displayed differently.

According to an embodiment, the electronic apparatus 100 may provide a feedback effect when the electronic apparatus 100 changes the first guide trajectory 320 to the first selection trajectory 330. For example, the electronic apparatus 100 may change the first guide trajectory 320 to the first selection trajectory 330 and display the first selection trajectory 330 while providing a feedback effect of changing the color of the first guide trajectory 320. However, embodiments of the present disclosure are not limited thereto, and the electronic apparatus 100 may change the first guide trajectory 320 to the first selection trajectory 330 and display the first selection trajectory 330 while providing a feedback effect of changing the thickness, brightness, blink rate, or the like of the first guide trajectory 320. As used herein, the feedback effect may be alternatively referred to as an image effect, a trajectory feedback, or the like.

Based on receiving no third user input including the instruction for selection (N at operation S235), the electronic apparatus 100 may receive a fourth user input including an instruction for movement in a second direction (operation S245). The electronic apparatus 100 may perform a different operation depending on whether the second direction is a direction identical with (equal to) the first direction or diagonal to the first direction.

In the case whether the second direction is a direction identical with (equal to) the first direction (Y at operation S250), the electronic apparatus 100 may place the focus on the third UI element 313 and display a second guide trajectory connecting the first, second and third UI elements 311 to 313 (operation S255). In one or more embodiments, based on receiving a fourth user input including an instruction for movement in the right direction while the first UI element 311 is selected and the focus is placed on the second UI element 312 as illustrated in FIG. 3D (Y at operation S250), the electronic apparatus 100, as illustrated in FIG. 3F, may place the focus on the third UI element 313, and display a second guide trajectory 340 connecting the first to third UI elements 311 to 313.

The electronic apparatus 100 may receive a fifth user input including an instruction for selection (operation S260).

The electronic apparatus 100 may display the first UI element 311, the second UI element 312, and the third UI element 313 in a manner that differentiates the first UI element 311, the second UI element 312, and the third UI element 313 from another UI element (e.g., the fourth to ninth UI elements 314 to 319), in response to the instruction for selection, change the second guide trajectory to a second selection trajectory, and display the second selection trajectory 350 (operation S265). In an embodiment, based on receiving a user input including an instruction for selection while the focus is placed on the third UI element 313 and the second guide trajectory 340 is displayed on the first to third UI elements 311 to 313 as illustrated in FIG. 3F, the electronic apparatus 100, as illustrated in FIG. 3G, may display the first UI element 311, the second UI element 312, and the third UI element 313 in a manner that differentiates the first UI element 311, the second UI element 312, and the third UI element 313 from another UI element (e.g., the fourth to ninth UI elements 314 to 319), change the second guide trajectory 340 to the second selection trajectory 350, and display the second selection trajectory 350. By selecting the first to third UI elements 311 to 313 at the same time (e.g., in the same input) and in the same manner the operations in S255 to S265 are performed, a multi-selection input selecting the first to third UI elements 311 to 313 at the same time may be possible without a direct instruction for selection of the second UI element 312. Accordingly, a selection trajectory connecting the first to third UI elements 311 to 313 may be input more readily.

In a case where the second direction is a direction different from the first direction (N at operation S250), the second direction may be a direction diagonal to the first direction (operation S270).

In such a case, the electronic apparatus 100 may place the focus on a fifth UI element 315 and display a third guide trajectory 360 connecting the first and fifth UI elements 311 and 315 (operation S275). In one or more embodiments, based on receiving a fourth user input including an instruction for movement in a downward direction while the first UI element 311 is selected and the focus is placed on the second UI element 312 as illustrated in FIG. 3D, the electronic apparatus 100, as illustrated in FIG. 3H, may place the focus on the fifth UI element 315 placed diagonally to the first UI element 311, and display a third guide trajectory 360 connecting the first and fifth UI elements 311 and 315.

Additionally, the electronic apparatus 100 may receive a sixth user input including an instruction for selection (operation S280).

The electronic apparatus 100 may display the first UI element 311 and the fifth UI element 315 in a manner that differentiates the first UI element 311 and the fifth UI element 315 from another UI element (e.g., the second UI element 312, the third UI element 313, the fourth UI element 314, and the sixth to ninth UI elements 316 to 319) in response to the instruction for selection, change the third guide trajectory 360 to a third selection trajectory 370, and display the third selection trajectory 370 (operation S280). In an embodiment, based on receiving a user input including an instruction for selection while the focus is placed on the fifth UI element 315 and the third guide trajectory 360 is displayed on the first and fifth UI elements 311 and 315, as illustrated in FIG. 3H, the electronic apparatus 100, as illustrated in FIG. 3I, may display the first UI element 311 and the fifth UI element 315 in a manner that differentiates the first UI element 311 and the fifth UI element 315 from another UI element (e.g., the second UI element 312, the third UI element 313, the fourth UI element 314, and the sixth to ninth UI elements 316 to 319), change the third guide trajectory 360 to a third selection trajectory 370, and display the third selection trajectory 370. By selecting the first and fifth UI elements 311 and 315 placed diagonally in the same manner operations S270 to S285 are performed, a selection trajectory connecting UI elements placed diagonally rather than straightly may be input more readily.

Although operations S270 to S285, as described with reference to FIGS. 3H and 3I, depict a use case in which the second direction is diagonal to the first direction and the fifth UI element 315 is subsequently selected, embodiments of the present disclosure are not limited in this regard. For example, the second direction may be perpendicular to the first direction and the fourth UI element 314 may be subsequently selected.

That is, as described with reference to FIGS. 3A, 3B, 3C, 3D, 3E, 3F, 3G, 3H, and 3I, the electronic apparatus 100 may input a pattern trajectory for user authentication by selecting a plurality of selection trajectories based on an instruction for movement in a direction and an instruction for selection. Additionally, the electronic apparatus 100 may perform user authentication by comparing an input pattern trajectory and a pre-stored pattern trajectory.

According to one or more embodiments, the electronic apparatus 100 may display a number UI for selecting a number by using a direction key, together with a pattern input UI, as described with reference to FIGS. 4A, 4B, and 5.

The electronic apparatus 100, as illustrated in FIG. 4A, may display a number UI 420 for selecting a number by using a direction key, together with a pattern input UI 410. The pattern input UI 410 may include and/or may be similar in many respects to the pattern input UI 310 described above with reference to FIGS. 2A, 2B, 3A, 3B, 3C, 3D, 3E, 3F, 3G, 3H, and 3I, and may include additional features not mentioned above. Consequently, repeated descriptions of the pattern input UI 410 described above with reference to FIGS. 2A, 2B, 3A, 3B, 3C, 3D, 3E, 3F, 3G, 3H, and 3I may be omitted for the sake of brevity.

The pattern input UI 410 and the number UI 420 may include a corresponding number. Additionally, the electronic apparatus 100 may input a pattern onto the pattern input UI 410 for a pattern input by selecting one or more numbers among a plurality of numbers included in the number UI 420 through a direction key and a selection key.

For example, based on receiving a plurality of user inputs selecting the number 1, selecting the number 3, selecting the number 5, selecting the number 7 and selecting the number 9 through the number UI 420, the electronic apparatus 100, as illustrated in FIG. 4B, may display a pattern trajectory corresponding to the plurality of user inputs on the pattern input UI 410. In an embodiment, the electronic apparatus 100 may select a number by using the direction key and selection key. That is, based on receiving a plurality of user inputs selecting the selection key while a focus is placed on the number 1, moving the focus to the number 3 through the direction key and selecting the selection key while the focus is placed on the number 3, moving the focus to the number 5 through the direction key and selecting the selection key while the focus is placed on the number 5, moving the focus to the number 7 through the direction key and selecting the selection key while the focus is placed on the number 7, and moving the focus on the number 9 though the direction key and selecting the selection key while the focus is placed on the number 9, the electronic apparatus 100 may receive the plurality of user inputs selecting the number 1, selecting the number 3, selecting the number 5, selecting the number 7, and selecting the number 9.

Additionally, the electronic apparatus 100 may perform user authentication by identifying whether an input pattern trajectory matches a stored pattern trajectory.

FIG. 5 is a flowchart illustrating a method by which user authentication is performed by using a pattern input UI and a number UI, according to an embodiment.

Referring to FIG. 5, each of the operations of the method 500 of performing user authentication may be performed sequentially, but may not necessarily be performed sequentially. For example, the order of each of the operations may be changed, and at least two (2) of the operations may be performed in parallel.

According to an embodiment, operations S510 to S570 may be performed by a processor (e.g., processor 190 of FIG. 1) of an electronic apparatus (e.g., electronic apparatus 100 of FIG. 1).

According to the method 500, an electronic apparatus 100 may display a number UI together with a pattern input UI (operation S510). In one or more embodiments, the electronic apparatus 100, as illustrated in FIG. 4A, may display a number UI 420 together with a pattern input UI 410.

The electronic apparatus 100 may identify whether a number included in the number UI is selected once (operation S520). For example, the number included in the number UI may be selected by a number key included in a remote controller and/or may be selected through a direction key and a selection key included in the remote controller.

In a case where a number included in the number UI is selected once (Y in operation S520), the electronic apparatus 100 may move a highlight to the selected number (operation S530). That is, when a number included in the number UI is selected once, the electronic apparatus 100 may move a highlight (or a focus) included in the number UI 420 to the selected number. For example, in a case where the number 3 among numbers included in the number UI is selected once, the electronic apparatus 100 may move the highlight to the number 3 from among the numbers included in the number UI 420. Alternatively, when the number included in the number UI is not selected (N in operation S520), the method 500 may return to operation S520 to wait for a selection.

The electronic apparatus 100 may identify whether the number included in the number UI is selected one more time (operation S540). For example, the number included in the number UI may be selected one more time (e.g., a second time) by using the number key included in the remote controller, and/or may be selected one more (e.g., the second time) time through the selection key included in the remote controller.

In a case where the number included in the number UI is selected one more time (e.g., a second time) (Y in operation S540), the electronic apparatus 100 may select the selected number (operation S550). That is, the electronic apparatus 100 may select the number at which the highlight (or focus) is placed. Alternatively, when the number included in the number UI is not selected a second time (N in operation S540), the method 500 may return to operation S520 to wait for a selection.

The electronic apparatus 100 may identify whether an obtained pattern matches a pre-stored pattern (operation S560). That is, the electronic apparatus 100 may identify whether a pattern obtained through the selected number matches a pre-stored pattern.

In a case where the obtained pattern does not match the pre-stored pattern (N at operation S560), the electronic apparatus 100 may return to operation S520 and may continue to attempt to obtain pattern information by performing operations S520 to S550. The electronic apparatus 100 may select a plurality of numbers based on the above-described method and obtain the pattern information.

In the case where the obtained pattern matches the pre-stored pattern (Y in operation S560), the electronic apparatus 100 may authenticate the user (operation S570).

Although the method 500 depicted in FIG. 5 describes authenticating a user based on a pattern obtained by using the number UI 420 in conjunction with the pattern input UI 410, embodiments of the present disclosure are not limited in this regard. For example, operations S560 and S570 may be performed using pattern information obtained in a manner similar to the controlling of the pattern input UI 310 described above with reference to FIGS. 2A, 2B, 3A, 3B, 3C, 3D, 3E, 3F, 3G, 3H, and 3I.

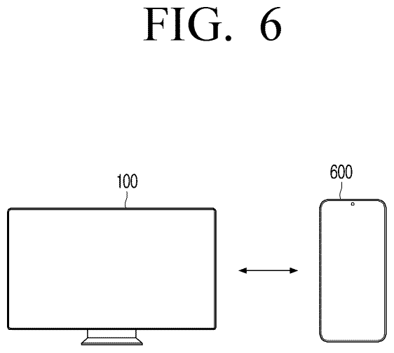

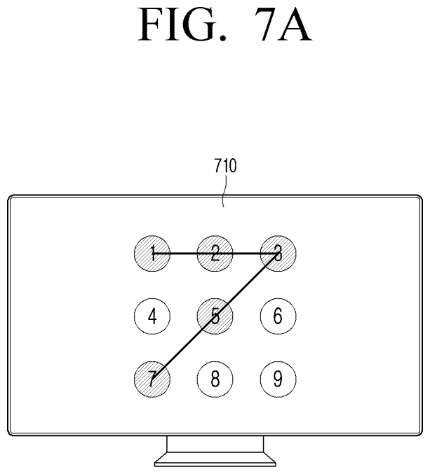

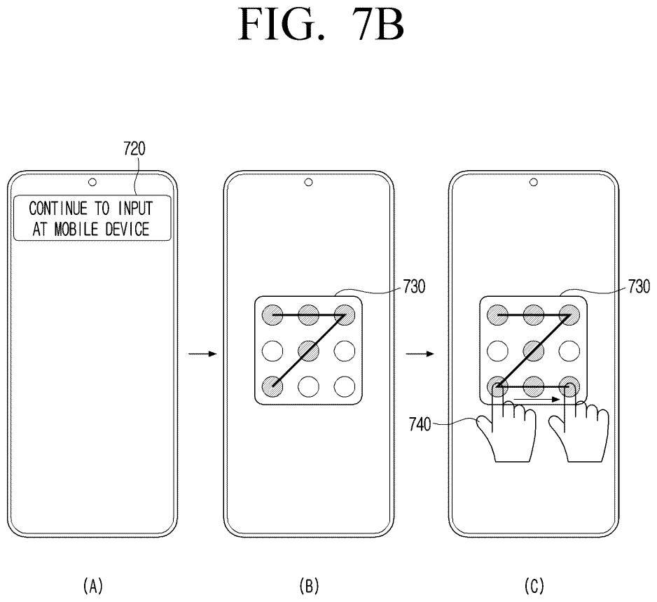

According to an embodiment, the electronic apparatus 100 may perform user authentication by interworking with a user terminal based on a pattern input, as described with reference to FIGS. 6, 7A, and 7B.

FIG. 6 is a view of an electronic apparatus and a user terminal, according to an embodiment. The user terminal 600, as illustrated in FIG. 6, may be and/or may include a smartphone. However, embodiments of the present disclosure are not limited thereto, and the user terminal 600 may be implemented as various types of user terminals such as, but not limited to, a tablet computer, a personal computer (PC), a laptop, or the like.

In an embodiment, the electronic apparatus 100 and the user terminal 600 may be communicably connected with each other. For example, in a case where the electronic apparatus 100 and the user terminal 600 approach each other, the electronic apparatus 100 and the user terminal 600 may communicably connect with each other through a short-range wireless communication interface (e.g., via Bluetooth™).

Referring to FIG. 7A, the electronic apparatus 100 may display a pattern input UI 710, and a user may input a pattern trajectory based on a method described with reference to FIGS. 2A, 2B, 3A, 3B, 3C, 3D, 3E, 3F, 3G, 3H, 3I, 4A, 4B, and 5. That is, the pattern input UI 710 may include and/or may be similar in many respects to the pattern input UI 310 and 410 described above with reference to FIGS. 2A, 2B, 3A, 3B, 3C, 3D, 3E, 3F, 3G, 3H, 3I, 4A, 4B, and 5, and may include additional features not mentioned above. Consequently, repeated descriptions of the pattern input UI 710 described above with reference to FIGS. 2A, 2B, 3A, 3B, 3C, 3D, 3E, 3F, 3G, 3H, 3I, 4A, 4B, and 5 may be omitted for the sake of brevity.

In an embodiment, the user terminal 600 may request information on a pre-input pattern trajectory from the electronic apparatus 100. For example, the user terminal 600 may request information on a pattern trajectory based on a user input for continuing to draw a pattern trajectory. However, embodiments of the present disclosure are not limited thereto. For example, the user terminal 600 may request the information on the pre-input pattern trajectory from the electronic apparatus 100, when the user terminal 600 approaches to the electronic apparatus 100.

Based on the electronic apparatus 100 accepting the request received from the user terminal 600, the electronic apparatus 100 may transmit the information on the pre-input pattern trajectory to the user terminal 600. For example, the electronic apparatus 100 may accept the request based on a user input. However, embodiments of the present disclosure are not limited thereto, and the electronic apparatus 100 may accept the request based on the user terminal 600 being a pre-registered terminal with the electronic apparatus 100.

In an embodiment, the user terminal 600 may receive pattern information including the pre-input pattern trajectory. For example, as illustrated in (A) of FIG. 7B, the user terminal 600 display a guide message 720 that may state “Continue to input the pattern on the mobile device” or the like.

The user terminal 600, as shown in (B) of FIG. 7B, may display a pattern input UI 730 and display the pre-input pattern trajectory, based on the information on the pre-input pattern trajectory included in the received pattern information. The pattern input UI 730 may include and/or may be similar in many respects to the pattern input UI 310, 410, and 710 described above with reference to FIGS. 2A, 2B, 3A, 3B, 3C, 3D, 3E, 3F, 3G, 3H, 3I, 4A, 4B, 5, and 7A, and may include additional features not mentioned above. Consequently, repeated descriptions of the pattern input UI 730 described above with reference to FIGS. 2A, 2B, 3A, 3B, 3C, 3D, 3E, 3F, 3G, 3H, 3I, 4A, 4B, 5, and 7A may be omitted for the sake of brevity.

The user terminal 600 may obtain a final pattern trajectory by receiving a user input 740 (e.g., a drag input) drawing a remaining pattern trajectory on the pre-input pattern trajectory, as illustrated in (C) of FIG. 7B.

The user terminal 600 may transmit information on the final pattern trajectory to the electronic apparatus 100, and the electronic apparatus 100 may perform user authentication based on whether the final pattern trajectory matches the pre-stored pattern trajectory. Alternatively or additionally, the user terminal 600 may perform user authentication based on whether the final pattern trajectory matches the pre-stored pattern trajectory and provide a result of the user authentication to the electronic apparatus 100.

Accordingly, the electronic apparatus 100 and the user terminal 600 may input the pattern trajectory by interworking with each other, potentially enhancing user convenience.

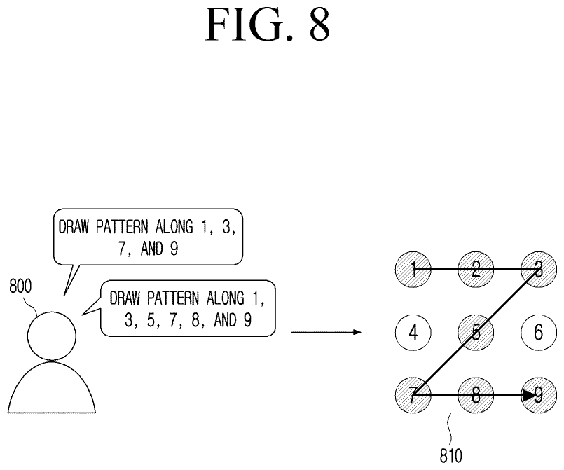

According to an embodiment, the electronic apparatus 100 may perform a pattern input based on a user voice or a user gesture, as described with reference to FIG. 8.

FIG. 8 is a view illustrating performing a pattern input based on a user voice, according to an embodiment.

In an embodiment, the electronic apparatus 100 may perform a pattern input based on a user voice including a number corresponding (assigned) to a UI element. For example, in a case where the user says, “Draw a pattern along 1, 3, 7, and 9”, or “Draw a pattern along 1, 2, 3, 5, 7, 8, and 9”, the electronic apparatus 100 may input a pattern trajectory 810 as illustrated in FIG. 8, based on the user voice.

In an embodiment, the electronic apparatus 100 may provide a feedback effect in real time (e.g., at substantially the same time the number is uttered) based on the electronic apparatus 100 recognizing the uttered number. For example, the electronic apparatus 100 may select “1” and “3” and then display a selection trajectory connecting “1” and “3” in a case where the user utters “1” and “3”, and, at a substantially similar and/or the same time, may provide a feedback effect on the selection trajectory.

Additionally, the electronic apparatus 100 may perform user authentication by identifying whether the pattern trajectory generated based on the user voice matches the pre-stored pattern trajectory.

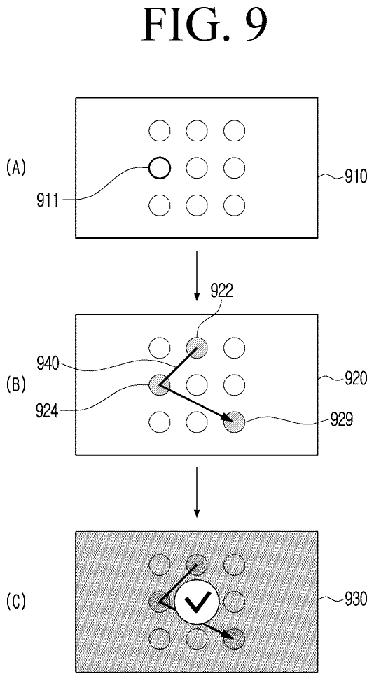

FIG. 9 is a view illustrating performing a pattern input based on a user gesture, according to an embodiment.

The electronic apparatus 100 may perform a pattern input by selecting a UI element based on a user gesture. That is, the electronic apparatus 100 may move a focus based on a hover gesture, as shown in (A) of FIG. 9. For example, the electronic apparatus 100 may move the focus to one of the plurality of UI elements of the pattern input UI 910 (e.g., UI element 911) based on the hover gesture.

The electronic apparatus 100 may select a UI element at which the focus is placed based on a grab gesture, as shown in (B) of FIG. 9. For example, the electronic apparatus 100 may select a second UI element 922 of the pattern input UI 920 based on a grab gesture while the focus is placed on the second UI element 922, move the focus onto a fourth UI element 924 by using a hover gesture, select the fourth UI element 924 based on a grab gesture while the focus is placed on the fourth UI element 924, move the focus onto a ninth UI element 929 by using a hover gesture, and select the ninth UI element 929 based on a grab gesture, to input a pattern trajectory 940.

The electronic apparatus 100 may authenticate the user by identifying whether the input pattern trajectory 940 matches the pre-stored pattern trajectory. In an embodiment, the electronic apparatus 100, as illustrated in (C) of FIG. 9, may provide a pattern input UI 930 indicating that the user authentication is completed.

By using the above-described methods, the electronic apparatus 100 may perform a pattern input based on various types of inputs, such that user authentication may be performed by using a pattern input UI, which may be displayed on a screen other than a touch screen.

The method according to the embodiments set forth herein may be provided in a computer program product. The computer program product may be exchanged between a seller and a purchaser as a commodity. The computer program product may be distributed in the form of a machine-readable storage medium (e.g., compact disc read only memory (CD-ROM)), or distributed (e.g., downloaded or uploaded) online through an application store (e.g., Play Store™) or directly between two user devices (e.g., smartphones). In the case of online distribution, at least part of the computer program product (e.g., a downloadable app) may be stored at least temporarily, or generated temporarily in a machine-readable storage medium such as, a server of a manufacturer, a server of an application store, memory of a relay server, or the like.

The method, according to the embodiments, may be implemented with software including instructions stored in a storage medium readable by a machine (e.g., a computer). The machine, as a device capable of calling the stored instructions from the storage media and operating according to the called instructions, may include an electronic apparatus according to the disclosed embodiments.

Meanwhile, the machine-readable storage medium may be provided in the form of a non-transitory storage medium. Herein, the “non-transitory storage medium” only means that the non-transitory storage medium is a tangible device and includes no signal (e.g., an electromagnetic wave), while the term does not distinguish semi-permanent storage and temporary storage of data in the storage medium. For example, the “non-transitory storage medium” may include a buffer in which data are temporarily stored.

When the instructions are executed by a processor, the processor may perform functions corresponding to the instructions directly or by using other elements under the control of the processor. The instructions may include a code generated or executed by a compiler or an interpreter.

While the example embodiments of the present disclosure are illustrated and described above, embodiments of the disclosure are not limited to the embodiments set forth herein, and certainly, various modifications thereof may be made by those skilled in the art to which the disclosure pertains, without departing from the scope the disclosure claimed in the section of claims, and should not be understood as separating from the technical spirit or prospect of the disclosure.

What is claimed is:

1. An electronic apparatus, comprising:
a display;
memory storing instructions; and
a processor,
wherein the instructions, when executed by the processor individually or collectively, cause the electronic apparatus to:
display, on the display, a pattern input user interface (UI) configured to perform a pattern input, the pattern input UI comprising a plurality of UI elements;
based on receiving a first user input comprising a first instruction instructing to perform a first selection while a focus is placed on a first UI element from among the plurality of UI elements, display the first UI element in a manner that differentiates the first UI element from remaining UI elements of the plurality of UI elements;
based on receiving a second user input comprising a second instruction instructing to perform a first movement in a first direction while the first UI element is selected, move the focus from the first UI element onto a second UI element of the plurality of UI elements disposed in the first direction from the first UI element, and display a first guide trajectory coupling the first UI element with the second UI element; and
based on receiving a third user input comprising a third instruction instructing to perform a second selection while the focus is placed on the second UI element and the first guide trajectory is displayed, display the first UI element and the second UI element in a manner that differentiates the first UI element and the second UI element from remaining UI elements of the plurality of UI elements, change the first guide trajectory to a first selection trajectory, and display the first selection trajectory.

2. The electronic apparatus of claim 1, wherein the instructions, when executed by the processor individually or collectively, further cause the electronic apparatus to:
based on receiving a fourth user input comprising a fourth instruction to perform a second movement in a second direction while the focus is placed on the second UI element and the first guide trajectory is displayed, move the focus from the second UI element onto a third UI element of the plurality of UI elements disposed in the second direction from the second UI element, and display a second guide trajectory coupling the first UI element with the third UI element.

3. The electronic apparatus of claim 2, wherein, based on the second direction being equal to the first direction, the second guide trajectory couples the first UI element and the second UI element with the third UI element.

4. The electronic apparatus of claim 3, wherein the instructions, when executed by the processor individually or collectively, further cause the electronic apparatus to:
based on receiving a fifth user input comprising a fifth instruction to perform a third selection while the focus is placed on the third UI element and the second guide trajectory is displayed, display the first UI element, the second UI element, and the third UI element in a manner that differentiates the first UI element, the second UI element, and the third UI element from remaining UI elements of the plurality of UI elements, change the second guide trajectory to a second selection trajectory, and display the second selection trajectory.

5. The electronic apparatus of claim 2, wherein, based on the second direction being a direction diagonal to the first direction, the second guide trajectory only couples the first UI element with the third UI element disposed diagonally from the first UI element.

6. The electronic apparatus of claim 5, wherein the instructions, when executed by the processor individually or collectively, further cause the electronic apparatus to:
based on receiving a sixth user input comprising a sixth instruction instructing to perform a fourth selection while the focus is placed on the third UI element and the second guide trajectory is displayed, display the first UI element and the third UI element in a manner that differentiates the first UI element and the third UI element from remaining UI elements of the plurality of UI elements, change the second guide trajectory to a third selection trajectory, and display the third selection trajectory.

7. The electronic apparatus of claim 1, wherein the instructions, when executed by the processor individually or collectively, further cause the electronic apparatus to:
based on the first guide trajectory being changed to the first selection trajectory, provide a feedback effect by changing a color of the first guide trajectory.

8. The electronic apparatus of claim 1, wherein the plurality of UI elements comprises a corresponding number of UI elements, and
wherein the instructions, when executed by the processor individually or collectively, further cause the electronic apparatus to display, together with the pattern input UI, a number UI configured to select a number by using a direction key.

9. The electronic apparatus of claim 8, wherein the instructions, when executed by the processor individually or collectively, further cause the electronic apparatus to:
based on selecting a first number included in the number UI once, receive a fourth user input comprising a fourth instruction instructing to perform a second movement in a direction of the first number; and
based on selecting a second number included in the number UI twice, receive a fifth user input comprising a fifth instruction to perform a third selection of the second number.

10. A control method of an electronic apparatus, the control method comprising:
displaying, on a display of the electronic apparatus, a pattern input user interface (UI) comprising a plurality of UI elements;
based on receiving a first user input comprising a first instruction instructing to perform a first selection while a focus is placed on a first UI element from among the plurality of UI elements, displaying the first UI element in a manner that differentiates the first UI element from remaining UI elements of the plurality of UI elements;
based on receiving a second user input comprising a second instruction instructing to perform a first movement in a first direction while the first UI element is selected, moving the focus from the first UI element onto a second UI element of the plurality of UI elements disposed in the first direction from the first UI element, and displaying a first guide trajectory coupling the first UI element with the second UI element; and
based on receiving a third user input comprising a third instruction instructing to perform a second selection while the focus is placed on the second UI element and the first guide trajectory is displayed, displaying the first UI element and the second UI element in a manner that differentiates the first UI element and the second UI element from remaining UI elements of the plurality of UI elements, changing the first guide trajectory to a first selection trajectory, and displaying the first selection trajectory.

11. The control method of claim 10, further comprising:
based on receiving a fourth user input comprising a fourth instruction to perform a second movement in a second direction while the focus is placed on the second UI element and the first guide trajectory is displayed, moving the focus from the second UI element onto a third UI element of the plurality of UI elements disposed in the second direction from the second UI element, and displaying a second guide trajectory coupling the first UI element with the third UI element.

12. The control method of claim 11, wherein, based on the second direction being equal to the first direction, the second guide trajectory couples the first UI element and the second UI element with the third UI element.

13. The control method of claim 12, further comprising:
based on receiving a fifth user input comprising a fifth instruction to perform a third selection while the focus is placed on the third UI element and the second guide trajectory is displayed, displaying the first UI element, the second UI element, and the third UI element in a manner that differentiates the first UI element, the second UI element, and the third UI element from remaining UI elements of the plurality of UI elements, changing the second guide trajectory to a second selection trajectory, displaying the second selection trajectory.

14. The control method of claim 11, wherein, based on the second direction being a direction diagonal to the first direction, the second guide trajectory only couples the first UI element with the third UI element disposed diagonally from the first UI element.

15. The control method of claim 14, further comprising:
based on receiving a sixth user input comprising a sixth instruction instructing to perform a fourth selection while the focus is placed on the third UI element and the second guide trajectory is displayed, displaying the first UI element and the third UI element in a manner that differentiates the first UI element and the third UI element from remaining UI elements of the plurality of UI elements, changing the second guide trajectory to a third selection trajectory, and displaying the third selection trajectory.

16. The control method of claim 10, further comprising:
based on the first guide trajectory being changed to the first selection trajectory, providing a feedback effect by changing a color of the first guide trajectory.

17. The control method of claim 10, wherein the plurality of UI elements comprises a corresponding number of UI elements, and
wherein the control method further comprises displaying, together with the pattern input UI, a number UI configured to select a number by using a direction key.

18. The control method of claim 17, further comprising:
based on selecting a first number included in the number UI once, receiving a fourth user input comprising a fourth instruction instructing to perform a second movement in a direction of the first number; and
based on selecting a second number included in the number UI twice, receiving a fifth user input comprising a fifth instruction to perform a third selection of the second number.

19. A control method of an electronic apparatus, the control method comprising:
displaying, on a display of the electronic apparatus, a pattern input user interface (UI) comprising a plurality of UI elements;
based on receiving a first user input comprising a first instruction instructing to perform a first selection while a focus is placed on a first UI element from among the plurality of UI elements, displaying the first UI element in a manner that differentiates the first UI element from remaining UI elements of the plurality of UI elements;
based on receiving a second user input comprising a second instruction instructing to perform a first movement in a first direction while the first UI element is selected, moving the focus from the first UI element onto a second UI element of the plurality of UI elements disposed in the first direction from the first UI element, and displaying a first guide trajectory coupling the first UI element with the second UI element;
based on receiving a third user input comprising a third instruction instructing to perform a second selection while the focus is placed on the second UI element and the first guide trajectory is displayed, displaying the first UI element and the second UI element in a manner that differentiates the first UI element and the second UI element from remaining UI elements of the plurality of UI elements, changing the first guide trajectory to a first selection trajectory, and displaying the first selection trajectory;
based on receiving a fourth user input comprising a fourth instruction to perform a second movement in a second direction while the focus is placed on the second UI element and the first guide trajectory is displayed, move the focus from the second UI element onto a third UI element of the plurality of UI elements disposed in the second direction from the second UI element, and display a second guide trajectory coupling the first UI element with the third UI element;
based on receiving a fifth user input comprising a fifth instruction to perform a third selection while the focus is placed on the third UI element and the second guide trajectory is displayed, display the first UI element, the second UI element, and the third UI element in a manner that differentiates the first UI element, the second UI element, and the third UI element from remaining UI elements of the plurality of UI elements, change the second guide trajectory to a second selection trajectory, and display the second selection trajectory; and
based on receiving a sixth user input comprising a sixth instruction instructing to perform a fourth selection while the focus is placed on the third UI element and the second guide trajectory is displayed, display the first UI element and the third UI element in a manner that differentiates the first UI element and the third UI element from remaining UI elements of the plurality of UI elements, change the second guide trajectory to a third selection trajectory, and display the third selection trajectory.

20. The control method of claim 19, wherein the plurality of UI elements comprises a corresponding number of UI elements, and
wherein the control method further comprises:
displaying, together with the pattern input UI, a number UI configured to select a number by using a direction key; and
based on selecting a first number included in the number UI once, receive a seventh user input comprising a seventh instruction instructing to perform a third movement in a direction of the first number; and
based on selecting a second number included in the number UI twice, receive an eighth user input comprising an eighth instruction to perform a fourth selection of the second number.
